(19) United States
(12) Patent Application Publication
(10) Pub. No.: US 2026/0161407 A1
(43) Pub. Date: Jun. 11, 2026

(54) METHOD AND APPARATUS FOR CONTROLLING DATA TRANSFER OF ARTIFICIAL INTELLIGENCE PROCESSOR BASED ON EXTENDED INSTRUCTION SET

(71) Applicant: ELECTRONICS AND TELECOMMUNICATIONS RESEARCH INSTITUTE, Daejeon (KR)

(72) Inventors: Hyun-Jeong KWON, Daejeon (KR); Ju-Yeob KIM, Daejeon (KR); Jin-Kyu KIM, Sejong-si (KR); Jae-Hoon CHUNG, Daejeon (KR); Yong-Cheol CHO, Daejeon (KR); Jae-Woong CHOI, Daejeon (KR); Jin-Ho HAN, Seoul (KR)

(21) Appl. No.: 19/409,096

(22) Filed: Dec. 4, 2025

(30) Foreign Application Priority Data
Dec. 9, 2024 (KR) 10-2024-0181878
Nov. 26, 2025 (KR) 10-2025-0181747

(51) Int. Cl. G06F 9/30; G06N 3/048

(52) U.S. Cl. CPC G06F 9/30181; G06N 3/048

(57) ABSTRACT

Disclosed herein are a method and apparatus for controlling data transfer of an artificial intelligence (AI) processor based on an extended instruction set. The AI processing apparatus includes a programmable processor core; and an operation accelerator not included in a pipeline path of the processor core, wherein the processor core includes a basic instruction set for performing a matrix multiplication operation and an activation function operation and an extended instruction set for data transfer with the operation accelerator, and wherein the extended instruction set is configured to perform data reading, writing and state control with the operation accelerator, a memory, an address region other than the memory, and a register group along a pipeline path of the processor core.

### CROSS REFERENCE TO RELATED APPLICATIONS

This application claims the benefit of Korean Patent Application Nos. 10-2024-0181878, filed Dec. 9, 2024 and 10-2025-0181747, filed Nov. 26, 2025, which are hereby incorporated by reference in their entireties into this application.

### BACKGROUND OF THE INVENTION

### 1. Technical Field

The present disclosure relates generally to a data transfer control technology for an artificial intelligence (AI) processor based on an extended instruction set, and more particularly to a technology to develop new instructions of multiple programmable processor cores that make up the interior of a chip to process an AI algorithm or perform parallel operations for massive data.

### 2. Description of Related Art

The advancement of artificial intelligence (AI) technologies is leading to the enhancement of performance of semiconductor chips, and the world's top semiconductor manufacturing and developing companies have released the associated semiconductor development. Hence, areas of semiconductor hardware development for high-performance processing of hyperscale and massive data are expected to grow constantly in the future.

Multiple programmable physical processor cores traditionally exist in a chip, and there are chip design technologies to perform parallel or pipeline data processing by programming the multiple processor cores separately. This chip structure may employ a parallel operation processing technology to reduce or accelerate a whole operation time by performing operations not sequentially but in parallel in multiple processor cores.

Most of these technologies are on a basis of a processor core that has a determined instruction set and performs logical and arithmetic operations according to input instructions, and the instruction set of the processor core has different sub-instructions that make up the instruction set depending on the logical and arithmetic operation to be performed by the processor core.

Especially, in order to enhance the performance of the process core, instructions to combine arithmetic operations or perform an operation using massive data such as a vector operation are developed and used.

### PRIOR ART DOCUMENTS

### Patent Documents

(Patent Document 1) U.S. Patent Application Publication No. US2020/0104690 Publication Date: Apr. 2, 2020 (Title: Neural processing unit (npu) direct memory access (ndma) hardware pre-processing and post-processing)

### SUMMARY OF THE INVENTION

Accordingly, the present disclosure has been made keeping in mind the above problems occurring in the prior art, and an object of the present disclosure is to develop new instructions of multiple programmable processor cores that make up the interior of a chip to process an artificial intelligence (AI) algorithm or perform parallel operations of massive data, and enhance the performance.

Another object of the present disclosure is to provide a new instruction set that an individual processor core in a chip comprised of multiple cores is able to have for data transfer between the individual processor core and a main memory area, thereby improving the existing inefficient data transfer.

A further object of the present disclosure is to improve inefficiency from existing simple ‘load’ and ‘store’ by providing extended instructions to effectively perform the tasks of repetitively reading and writing matrix and vector-sized data required for operations from and to the main memory.

In accordance with an aspect of the present disclosure to accomplish the above objects, there is provided an artificial intelligence (AI) processing apparatus, including a programmable processor core; and an operation accelerator not included in a pipeline path of the processor core, wherein the processor core includes a basic instruction set for performing a matrix multiplication operation and an activation function operation and an extended instruction set for data transfer with the operation accelerator, and wherein the extended instruction set is configured to perform data reading, writing and state control with the operation accelerator, a memory, an address region other than the memory, and a register group along a pipeline path of the processor core.

The extended instruction set may correspond to an R-type format of RISC-V.

The extended instruction set may include a first instruction configured to control reading out a designated register value in the operation accelerator and writing the register value to a general-purpose register designated along the pipeline path, a second instruction configured to control writing a specified value to a designated register in the operation accelerator, a third instruction configured to control reading out a value in a designated address in the memory and writing the value to a designated register in the operation accelerator or reading out a designated register value in the operation accelerator and writing the register value to a designated address in the memory, a fourth instruction configured to control waiting until an operation of the operation accelerator is completed, a fifth instruction configured to control reading a unique identifier of the AI processing apparatus, a sixth instruction configured to control reading a value of a specified data size from a designated address in an address region other than the memory and writing the value to a general-purpose register designated along the pipeline path, and a seventh instruction configured to control writing a specified value of a specified data size to a designated address in an address region other than the memory.

The third instruction may control writing the value read out from the designated address in the memory to the designated register in the operation accelerator according to a transfer control rule mapped to a rs2 field when a most significant bit value of the third instruction is ‘0’, and control writing the value read out from the designated register in the operation accelerator to the designated address in the memory when the most significant bit value of the third instruction is ‘1’.

The transfer control rule may include a ‘trid’ field including a transaction ID for a memory reading or writing transfer, a ‘trlen’ field assigning a length of data for transfer, a ‘trsel’ field selecting a type of an accelerator register that is a transfer target, a ‘dtc’ field designating whether to convert a type of read-out data, a ‘ws’ field designating whether to perform a write strobe operation in data writing, and a ‘transpose’ field designating whether to perform matrix transpose on data.

The ‘trid’ field may be mapped to 0 to 4th bits of the rs2 field, the ‘trlen’ field may be mapped to 8th to 15th bits of the rs2 field, the ‘trsel’ field may be mapped to 16th to 20th bits of the rs2 field, the ‘dtc’ field may be mapped to 21st and 22nd bits of the rs2 field, the ‘ws’ field may be mapped to 23rd to 54th bits of the rs2 field, and the ‘transpose’ field may be mapped to a 55th bit of the rs2 field.

The specified data size may correspond to one of 1 byte, 2 bytes, 4 bytes and 8 bytes, and the sixth instruction and the seventh instruction may add suffix a character referring to a data size to a name of the instruction to distinguish the specified data size.

In accordance with another aspect of the present disclosure to accomplish the above objects, there is provided a method of controlling data transfer to perform an AI operation includes, by a programmable processor core, executing a basic instruction set to perform a matrix multiplication operation and an activation function operation; and executing an extended instruction set to control data transfer with an operation accelerator not included in a pipeline path of the processor core, wherein the extended instruction set is configured to perform data reading, writing and state control with the operation accelerator, memory, an address region other than memory, and a register group along a pipeline path of the processor core.

The extended instruction set may correspond to an R-type format of RISC-V.

The extended instruction set may include a first instruction configured to control reading out a designated register value in the operation accelerator and writing the register value to a general-purpose register designated along the pipeline path, a second instruction configured to control writing a specified value to a designated register in the operation accelerator, a third instruction configured to control reading out a value in a designated address in the memory and writing the value to a designated register in the operation accelerator or reading out a designated register value in the operation accelerator and writing the register value to a designated address in the memory, a fourth instruction configured to control waiting until an operation of the operation accelerator is completed, a fifth instruction configured to control reading a unique identifier of the AI processing apparatus, a sixth instruction configured to control reading a value of a specified data size from a designated address in an address region other than the memory and writing the value to a general-purpose register designated along the pipeline path, and a seventh instruction configured to control writing a specified value of a specified data size to a designated address in an address region other than the memory.

The third instruction may control writing the value read out from the designated address in the memory to the designated register in the operation accelerator according to a transfer control rule mapped to a rs2 field when a most significant bit value of the third instruction is ‘0’, and control writing the value read out from the designated register in the operation accelerator to the designated address in the memory when the most significant bit value of the third instruction is ‘1’.

The transfer control rule may include a ‘trid’ field including a transaction ID for a memory reading or writing transfer, a ‘trlen’ field assigning a length of data for transfer, a ‘trsel’ field selecting a type of an accelerator register that is a transfer target, a ‘dtc’ field designating whether to convert a type of read-out data, a ‘ws’ field designating whether to perform a write strobe operation in data writing, and a ‘transpose’ field designating whether to perform matrix transpose on data.

The ‘trid’ field may be mapped to 0 to 4th bits of the rs2 field, the ‘trlen’ field may be mapped to 8th to 15th bits of the rs2 field, the ‘trsel’ field may be mapped to 16th to 20th bits of the rs2 field, the ‘dtc’ field may be mapped to 21st and 22nd bits of the rs2 field, the ‘ws’ field may be mapped to 23rd to 54th bits of the rs2 field, and the ‘transpose’ field may be mapped to a 55th bit of the rs2 field.

The specified data size may correspond to one of 1 byte, 2 bytes, 4 bytes and 8 bytes, and the sixth instruction and the seventh instruction may add a suffix character referring to a data size to a name of the instruction to distinguish the specified data size.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 illustrates an artificial intelligence (AI) processing apparatus according to an embodiment of the present disclosure;

FIG. 2 illustrates an example of register files of an operation accelerator in the AI processing apparatus illustrated in FIG. 1;

FIG. 3 illustrates an example of an operation accelerator core according to the present disclosure;

FIG. 4 illustrates an example of a format of an extended instruction set according to the present disclosure;

FIG. 5 illustrates an example of a bit format of a transfer control rule according to the present disclosure;

FIG. 6 is an operation flowchart illustrating an example of a method of controlling data transfer to perform an AI operation according to an embodiment of the present disclosure; and

FIG. 7 is an operation flowchart illustrating a detailed example of a procedure for processing a third instruction of an extended instruction set according to the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to make the gist of the present disclosure unnecessarily obscure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated to make the description clearer.

In the present specification, each of phrases such as “A or B”, “at least one of A and B”, “at least one of A or B”, “A, B, or C”, “at least one of A, B, and C”, and “at least one of A, B, or C” may include any one of the items enumerated together in the corresponding phrase, among the phrases, or all possible combinations thereof.

Hereinafter, embodiments of the present disclosure will be described in detail with reference to the attached drawings.

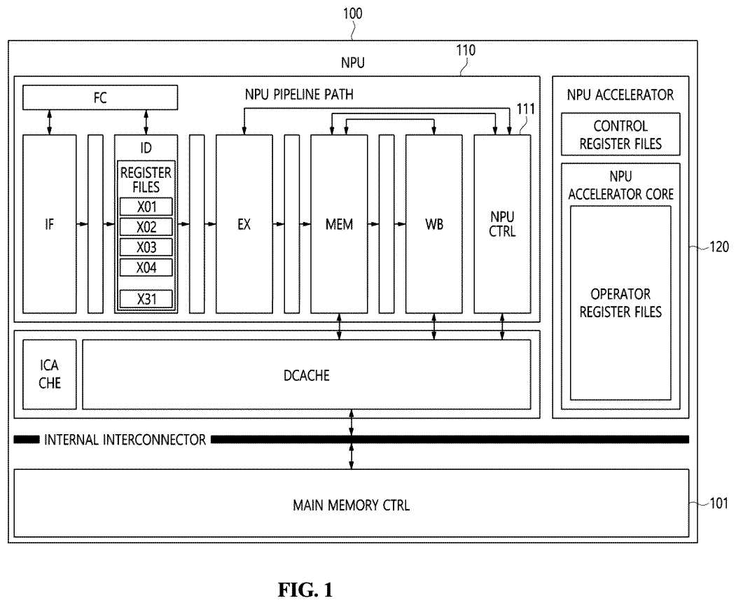

FIG. 1 illustrates an artificial intelligence (AI) processing apparatus according to an embodiment of the present disclosure.

Referring to FIG. 1, the AI processing apparatus according to an embodiment of the present disclosure includes a programmable processor core 110 and an operation accelerator 120 that is not included in pipeline paths of the processor core 110.

In this case, the processor core 110 may include a basic instruction set for performing a matrix multiplication operation and an activation function operation, and an extended instruction set for data transfer with the operation accelerator 120.

The extended instruction set may be configured to perform data reading, writing and state control with the operation accelerator 120, a memory, an address region other than the memory, and a register group along the pipeline path of the processor core 110.

In the following description, assume that the AI processing apparatus is a neural processing unit (NPU) for convenience of explanation.

For example, referring to FIG. 1, NPU pipeline paths (NPPs) may include an NPU control (NC) block 111 to execute the extended instruction set proposed in the present disclosure based on a general instruction set processing system. The NC block 111 may correspond to an extended instruction set execution block proposed in the present disclosure.

In this case, the NC block 111 included in the NPPs is controlled by an instruction included in the extended instruction set to effectively access register files inside an NPU accelerator (NA) (NARF).

The existing general system may be used to access a main memory illustrated in FIG. 1 by controlling a main memory control (MMC) connected to an internal interconnector (II) through a cache (CC) comprised of an icache and a dcache. After this, a tag may be checked for required data inside the CC and access to an external memory may be performed.

Writing tasks and reading tasks to and from main memory addresses (MMAR) may be formed by accessing only to the CC or to the MMC through the CC.

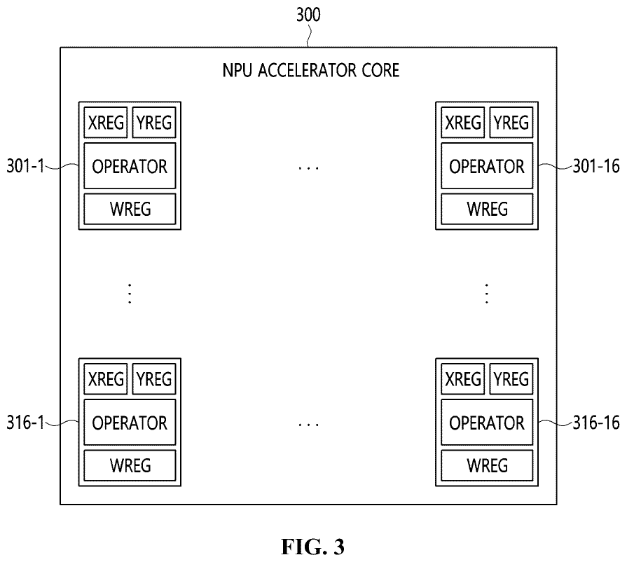

In this case, an NPU accelerator core (NAC) that performs an actual operation may be included in the NA, the operation accelerator 120, and referring to FIG. 3, there may be 16×16 (i.e., 256) operators 301-1 to 316-16 in the NAC 300 which are able to perform 4-byte floating point operations.

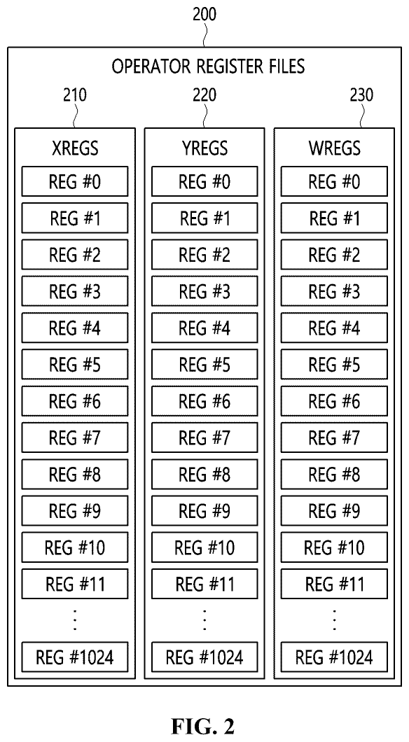

For the operators, there may be XREGs 210, YREGs 220, and WREGs that are registers for storing the results as illustrated in FIG. 2.

The extended instruction set according to the present disclosure may be summarized as those related to data transfers between the registers of the NAC 300 and the memory or general-purpose registers in the NPP.

The extended instruction set may correspond to an R-type format of RISC-V.

The extended instruction set may include a first instruction configured to control reading out a designated register value in the operation accelerator 120 and writing it to a general-purpose register designated along a pipeline path, a second instruction configured to control writing a specified value to a designated register in the operation accelerator 120, a third instruction configured to control reading out a value in a designated address in the memory and writing it to a designated register in the operation accelerator 120 or reading out a designated register value in the operation accelerator 120 and writing it to a designated address in the memory, a fourth instruction configured to control waiting until an operation of the operation accelerator 120 is completed, a fifth instruction configured to control reading a unique identifier of the AI processing apparatus 100, a sixth instruction configured to control reading a value of a specified data size from a designated address in an address region other than the memory and writing the value to a general-purpose register designated along the pipeline path, and a seventh instruction configured to control writing a specified value of a specified data size to a designated address in an address region other than the memory.

For example, the extended instruction set may be described as in Table 1.

TABLE 1

| Sequence | Instructions | Summarized description |
|---|---|---|
| 1 | ANCTR | Read out a designated register value in NARF |
| | (first | and write it to a designated general-purpose |
| | instruction) | register in the NPP |
| 2 | ANCTW | Write a specified value to a designated register |
| | (second | in NARF |
| | instruction) | |
| 3 | ANCTCA | Read out a value in a designated address in |
| | (third | MMAR and write it to a designated register in |
| | instruction) | NARF, or read out a designated register value |
| | | in NARF and write it to a designated address |
| | | in MMAR |
| 4 | ANCTXM | Perform a waiting task until NA completes an |
| | (fourth | operation |
| | instruction) | |
| 5 | AGCI | Read out a unique ID value of NPU |
| | (fifth | |
| | instruction) | |
| 6 | ALDNx* | Read out a value of x* size in a designated |
| | | address in an address region other than MMAR |
| | | and write it to a general-purpose register in |
| | | NPP |
| 7 | ASDNx* | Write a specified value of x* size to a |
| | | designated address in an address region other |
| | | than MMAR |

According to the disclosure, data transfer efficiency in matrix and vector operations may be enhanced by adding the extended instructions as in Table 1 to an individual processor core of a chip for processing an AI algorithm, the chip being comprised of multiple processor cores.

The third instruction may control writing the value read out from the designated address in the memory to the designated register in the operation accelerator 120 according to a transfer control rule mapped to the rs2 field when the most significant bit value of the third instruction is ‘0’, and control writing the value read out from the designated register in the operation accelerator to the designated address in the memory when the most significant bit value of the third instruction is ‘1’.

The transfer control rule may include a ‘trid’ field including a transaction ID for a memory reading or writing transfer, a ‘trlen’ field assigning a length of data for transfer, a ‘trsel’ field selecting a type of an accelerator register that is a transfer target, a ‘dtc’ field designating whether to convert a type of read-out data, a ‘ws’ field designating whether to perform a write strobe operation in data writing, and a ‘transpose’ field designating whether to perform matrix transpose on data.

The ‘trid’ field may be mapped to 0 to 4th bits of the rs2 field, the ‘trlen’ field may be mapped to 8th to 15th bits of the rs2 field, the ‘trsel’ field may be mapped to 16th to 20th bits of the rs2 field, the ‘dtc’ field may be mapped to 21st and 22nd bits of the rs2 field, the ‘ws’ field may be mapped to 23rd to 54th bits of the rs2 field, and the ‘transpose’ field may be mapped to a 55th bit of the rs2 field.

The specified data size may correspond to one of 1 byte, 2 bytes, 4 bytes and 8 bytes.

The sixth instruction and seventh instruction may add a suffix character referring to a data size to a name of the instruction to distinguish the designated data size.

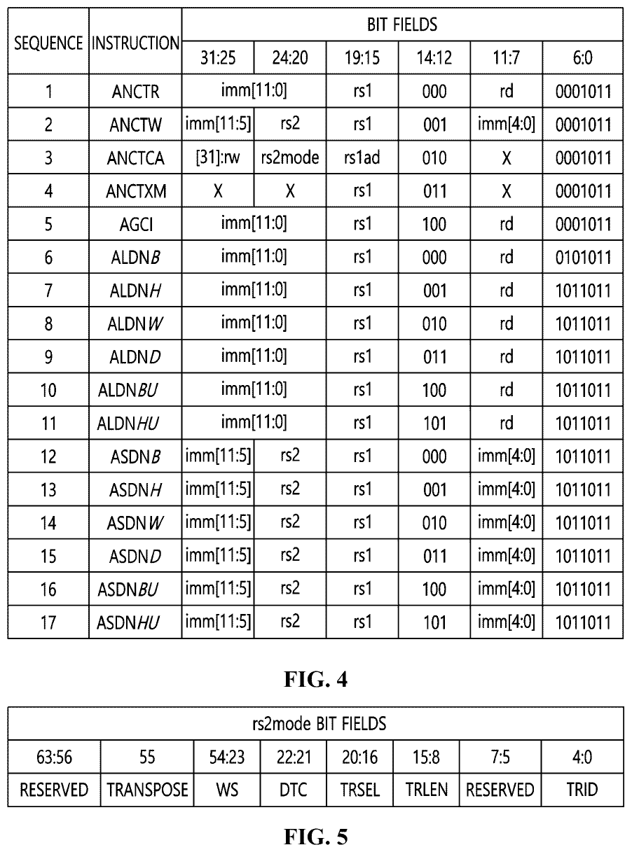

Operations of the instructions will now be described in detail with reference to an example of a format of the extended instruction set according to the present disclosure as illustrated in FIG. 4.

Referring first to bit fields of the instruction ‘ANCTR’ illustrated in FIG. 4, according to the instruction ‘ANCTR’, region {imm[11:0], rs1[31:00]} may be set to a register index in the NA module, and an NA register value may be read out and written to a general-purpose register designated to correspond to ‘rd’.

Referring also to bit fields of the instruction ‘ANCTW’ illustrated in FIG. 4, according to the instruction ‘ANCTW’, region {imm[11:0], rs1[31:00]} may be set to a register index in the NA module, and a value of rs2 may be written to the set register.

Referring also to bit fields of the instruction ‘ANCTCA’ illustrated in FIG. 4, when the most significant bit value [31] is ‘0’, a value corresponding to memory region address rslad[47:00] may be read out, and data read-out from memory may be written to an NA register according to an ‘rs2mode’ rule corresponding to a transfer control rule. When the most significant bit value [31] is ‘1’, a task of reading from an NA register row start index, rslad[52:48] and writing to a memory start address corresponding to rslad[47:00] may be performed.

A bit field configuration of rs2mode corresponding to the transfer control rule may correspond to FIG. 5.

A description of each bit field may correspond to Table 2.

TABLE 2

| Mode | Description |
|---|---|
| Trid | when [31] is 0, a transfer ID for read transfer of memory data |
| | when [31] is 1, a transfer ID for write transfer of memory data |
| Trlen | when [31] is 0, data length to be read out consecutively in 32 |
| | byte units starting from memory address rs1ad[47:00] |
| | when [31] is 1, data length to be written in 32 byte units |
| | starting from memory address rs1ad[47:00] |
| Trsel | when [31] is 0, a type of a register in NA for loading read-out |
| | memory data |
| | when [31] is 1, a type of a register in NA to be accessed to |
| | write to memory |
| Dtc | when [31] is 0, change and load a data type of read-out |
| | memory data |
| | when [31] is 1, not used |
| ws | when [31] is 0, not used |
| | when [31] is 1, perform a write strobe function on data |
| transpose | when [31] is 0, perform matrix transpose on read-out memory |
| | data and load the result to a register in NA |
| | when [31] is 1, not used |

Referring also to bit fields of instruction ‘AGCI’ illustrated in FIG. 4, a unique ID in a chip of NPU may be read out and written to a rd register according to the instruction ‘AGCI’.

Referring also to bit fields of instruction ‘ALDNx’ illustrated in FIG. 4, a task of reading from a device register in chip other than a memory address region may be performed by performing a non-cacheable load operation according to the instruction ‘ALDNx’.

Referring also to bit fields of instruction ‘ASDNx’ illustrated in FIG. 4, a task of writing to a device register in chip other than a memory address region may be performed by performing a non-cacheable store operation according to the instruction ‘ASDNx’.

As such, data reading and writing tasks may be effectively performed through the extended instruction set, and consecutive data transfers may be enabled with one instruction in the NPU architecture having an NA specialized in matrix and vector operations.

Furthermore, eliminating the need for loading an additional instruction may lead to the advantages of enhancing performance and reducing power consumption, and to attaining a high data transfer rate to an internal chip interconnect with sufficient performance.

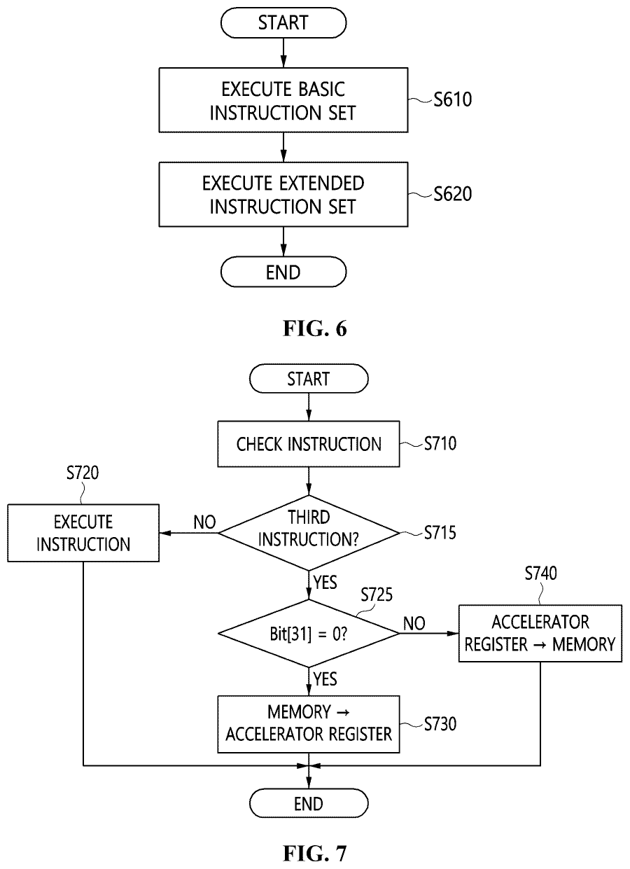

FIG. 6 is an operation flowchart illustrating an example of a method of controlling data transfer to perform an AI operation according to an embodiment of the present disclosure.

Referring to FIG. 6, a method of controlling data transfer to perform an AI operation according to an embodiment of the present disclosure is performed by a programmable processor core executing a basic instruction set to perform a matrix multiplication operation and an activation function operation.

Furthermore, the method of controlling data transfer to perform an AI operation according to an embodiment of the present disclosure is performed by the programmable processor core executing the extended instruction set to control data transfer with the operation accelerator that is not included in the pipeline path of the processor core at step S620.

The extended instruction set may be configured to perform data reading, writing and state control with the operation accelerator, a memory, an address region other than the memory, and a register group along a pipeline path of the processor core.

The extended instruction set may correspond to an R-type format of RISC-V.

The extended instruction set may include a first instruction configured to control reading out a designated register value in the operation accelerator 120 and writing it to a general-purpose register designated along a pipeline path, a second instruction configured to control writing a specified value to a designated register in the operation accelerator 120, a third instruction configured to control reading out a value in a designated address in the memory and writing it to a designated register in the operation accelerator 120 or reading out a designated register value in the operation accelerator 120 and writing it to a designated address in the memory, a fourth instruction configured to control waiting until an operation of the operation accelerator 120 is completed, a fifth instruction configured to control reading a unique identifier of the AI processing apparatus 100, a sixth instruction configured to control reading a value of a specified data size from a designated address in an address region other than the memory and writing the value to a general-purpose register designated along the pipeline path, and a seventh instruction configured to control writing a specified value of a specified data size to a designated address in an address region other than the memory.

The third instruction may control writing the value read out from the designated address in the memory to the designated register in the operation accelerator 120 according to a transfer control rule mapped to the rs2 field when the most significant bit value of the third instruction is ‘0’, and control writing the value read out from the designated register in the operation accelerator to the designated address in the memory when the most significant bit value of the third instruction is ‘1’.

The transfer control rule may include a ‘trid’ field including a transaction ID for a memory reading or writing transfer, a ‘trlen’ field assigning a length of data for transfer, a ‘trsel’ field selecting a type of an accelerator register that is a transfer target, a ‘dtc’ field designating whether to convert a type of read-out data, a ‘ws’ field designating whether to perform a write strobe operation in data writing, and a ‘transpose’ field designating whether to perform matrix transpose on data.

The ‘trid’ field may be mapped to 0 to 4th bits of the rs2 field, the ‘trlen’ field may be mapped to 8th to 15th bits of the rs2 field, the ‘trsel’ field may be mapped to 16th to 20th bits of the rs2 field, the ‘dtc’ field may be mapped to 21st and 22nd bits of the rs2 field, the ‘ws’ field may be mapped to 23rd to 54th bits of the rs2 field, and the ‘transpose’ field may be mapped to a 55th bit of the rs2 field.

The specified data size may correspond to one of 1 byte, 2 bytes, 4 bytes and 8 bytes.

The sixth instruction and seventh instruction may add a suffix character referring to a data size to a name of the instruction to distinguish the designated data size.

A specific operation procedure for the method of controlling data transfer was described in detail in connection with FIG. 1, so the description thereof will not be repeated.

FIG. 7 is an operation flowchart illustrating a detailed example of a procedure for processing a third instruction of an extended instruction set according to the present disclosure.

Referring to FIG. 7, a procedure for processing the third instruction of the extended instruction set may include checking an input instruction at step S710, determining whether the instruction is the third instruction at step S715, and performing an operation according to the input instruction when the input instruction is not the third instruction at step S720.

When the input instruction is the third instruction as a result of the determining, whether the most significant bit [31] is 0 may be determined at step S725, and a value in the memory region address may be read out and written to a register of the operation accelerator when [31] is 0 at step S730.

Furthermore, when [31] is 1 as a result of determining at step S725, a value may be read out from a register in the operation accelerator and written to a memory address, at step S740.

According to the present disclosure, data reading and writing tasks may be effectively performed with an NPU architecture.

According to the present disclosure, consecutive data transfers may also be enabled with one instruction in the NPU architecture having an operation accelerator specialized in matrix and vector operations.

According to the present disclosure, performance enhancement and power savings are achieved without loading an additional instruction.

As described above, in the method and apparatus for controlling data transfer of an AI processor based on an extended instruction set according to the present disclosure, the configurations and schemes in the above-described embodiments are not limitedly applied, and some or all of the above embodiments can be selectively combined and configured so that various modifications are possible.

What is claimed is:

1. An artificial intelligence (AI) processing apparatus, comprising:
a programmable processor core; and
an operation accelerator not included in a pipeline path of the processor core,
wherein the processor core comprises a basic instruction set for performing a matrix multiplication operation and an activation function operation and an extended instruction set for data transfer with the operation accelerator, and
wherein the extended instruction set is configured to perform data reading, writing and state control with the operation accelerator, a memory, an address region other than the memory, and a register group along a pipeline path of the processor core.

2. The AI processing apparatus of claim 1, wherein the extended instruction set is configured to correspond to an R-type format of RISC-V.

3. The AI processing apparatus of claim 2, wherein the extended instruction set comprises:
a first instruction configured to control reading out a designated register value in the operation accelerator and writing the register value to a general-purpose register designated along the pipeline path,
a second instruction configured to control writing a specified value to a designated register in the operation accelerator,
a third instruction configured to control reading out a value in a designated address in the memory and writing the value to a designated register in the operation accelerator or reading out a designated register value in the operation accelerator and writing the register value to a designated address in the memory,
a fourth instruction configured to control waiting until an operation of the operation accelerator is completed,
a fifth instruction configured to control reading a unique identifier of the AI processing apparatus,
a sixth instruction configured to control reading a value of a specified data size from a designated address in an address region other than the memory and writing the value to a general-purpose register designated along the pipeline path, and
a seventh instruction configured to control writing a specified value of a specified data size to a designated address in an address region other than the memory.

4. The AI processing apparatus of claim 3, wherein the third instruction is configured to:
control writing the value read out from the designated address in the memory to the designated register in the operation accelerator according to a transfer control rule mapped to a rs2 field when a most significant bit value of the third instruction is ‘0’, and
control writing the value read out from the designated register in the operation accelerator to the designated address in the memory when the most significant bit value of the third instruction is ‘1’.

5. The AI processing apparatus of claim 4, wherein the transfer control rule comprises a ‘trid’ field including a transaction ID for a memory reading or writing transfer, a ‘trlen’ field assigning a length of data for transfer, a ‘trsel’ field selecting a type of an accelerator register that is a transfer target, a ‘dtc’ field designating whether to convert a type of read-out data, a ‘ws’ field designating whether to perform a write strobe operation in data writing, and a ‘transpose’ field designating whether to perform matrix transpose on data.

6. The AI processing apparatus of claim 5, wherein:
the ‘trid’ field is mapped to 0 to 4th bits of the rs2 field,
the ‘trlen’ field is mapped to 8th to 15th bits of the rs2 field,
the ‘trsel’ field is mapped to 16th to 20th bits of the rs2 field,
the ‘dtc’ field is mapped to 21st and 22nd bits of the rs2 field,
the ‘ws’ field is mapped to 23rd to 54th bits of the rs2 field, and
the ‘transpose’ field is mapped to a 55th bit of the rs2 field.

7. The AI processing apparatus of claim 3, wherein:
the specified data size corresponds to one of 1 byte, 2 bytes, 4 bytes and 8 bytes, and
the sixth instruction and the seventh instruction add a suffix character referring to a data size to a name of the instruction to distinguish the specified data size.

8. A method of controlling data transfer to perform an artificial intelligence (AI) operation, comprising:
by a programmable processor core,
executing a basic instruction set to perform a matrix multiplication operation and an activation function operation; and
executing an extended instruction set to control data transfer with an operation accelerator not included in a pipeline path of the processor core,
wherein the extended instruction set is configured to perform data reading, writing and state control with the operation accelerator, a memory, an address region other than the memory, and a register group along a pipeline path of the processor core.

9. The method of claim 8, wherein the extended instruction set is configured to correspond to an R-type format of RISC-V.

10. The method of claim 9, wherein the extended instruction set comprises:
a first instruction configured to control reading out a designated register value in the operation accelerator and writing the register value to a general-purpose register designated along the pipeline path,
a second instruction configured to control writing a specified value to a designated register in the operation accelerator,
a third instruction configured to control reading out a value in a designated address in the memory and writing the value to a designated register in the operation accelerator or reading out a designated register value in the operation accelerator and writing the register value to a designated address in the memory,
a fourth instruction configured to control waiting until an operation of the operation accelerator is completed,
a fifth instruction configured to control reading a unique identifier of an AI processing apparatus,
a sixth instruction configured to control reading out a value of a specified data size from a designated address in an address region other than the memory and writing the value to a general-purpose register designated along the pipeline path, and
a seventh instruction configured to control writing a specified value of a specified data size to a designated address in an address region other than the memory.

11. The method of claim 10, wherein the third instruction is configured to:
control writing the value read out from the designated address in the memory to the designated register in the operation accelerator according to a transfer control rule mapped to a rs2 field when a most significant bit value of the third instruction is ‘0’, and control writing the value read out from the designated register in the operation accelerator to the designated address in the memory when the most significant bit value of the third instruction is ‘1’.

12. The method of claim 11, wherein the transfer control rule comprises a ‘trid’ field including a transaction ID for a memory reading or writing transfer, a ‘trlen’ field assigning a length of data for transfer, a ‘trsel’ field selecting a type of an accelerator register that is a transfer target, a ‘dtc’ field designating whether to convert a type of read-out data, a ‘ws’ field designating whether to perform a write strobe operation in data writing, and a ‘transpose’ field designating whether to perform matrix transpose on data.

13. The method of claim 12, wherein:
the ‘trid’ field is mapped to 0 to 4th bits of the rs2 field,
the ‘trlen’ field is mapped to 8th to 15th bits of the rs2 field,
the ‘trsel’ field is mapped to 16th to 20th bits of the rs2 field,
the ‘dtc’ field is mapped to 21st and 22nd bits of the rs2 field,
the ‘ws’ field is mapped to 23rd to 54th bits of the rs2 field, and
the ‘transpose’ field is mapped to a 55th bit of the rs2 field.

14. The method of claim 10, wherein:
the specified data size corresponds to one of 1 byte, 2 bytes, 4 bytes and 8 bytes, and
the sixth instruction and the seventh instruction add a suffix character referring to a data size to a name of the instruction to distinguish the specified data size.
